(19) United States
(12) Patent Application Publication
(10) Pub. No.: US 2012/0164950 A1
(43) Pub. Date: Jun. 28, 2012

(54) Cognitive Radio Transmission

(75) Inventor: Markus Nentwig, Helsinki (FI)

(73) Assignee: NOKIA CORPORATION, Espoo (FI)

(21) Appl. No.: 13/376,358

(22) PCT Filed: Jun. 5, 2009
(86) PCT No.: PCT/FI2009/050484

§ 371 Date: Dec. 5, 2011

(51) Int. Cl. H04B 15/00; H04B 1/04

(52) U.S. Cl. 455/63.1; 455/114.2

(57) ABSTRACT

A method, an apparatus, and a computer program for performing cognitive communications in a radio environment are presented. First, a radio communication device estimates a time-varying interference environment in a radio communication channel. On the basis of the estimation, a future interference environment is predicted from time-varying characteristics of the estimated interference. Upon predicting the future interference environment, a radio transmitter is configured to apply transmission parameters to be used in a future transmission time instant for which the interference environment has been predicted. As a consequence, the transmission parameters are selected proactively to match with the predicted interference environment. The transmission parameters may be configured as time-variant.

### FIELD

The invention relates to the field of radio telecommunications and, particularly, to cognitive radio communications in an interfered communication environment.

### BACKGROUND

A radio communication environment interferes with radio communication signals exchanged between two radio communication devices in many ways. A variety of mechanisms results in a degradation of signal quality, such as attenuation caused by free space path loss, shadowing caused by obstacles between the radio communication devices, fading caused by multipath propagation, thermal noise, weather conditions, etc. Additionally, a frequency spectrum used by the radio communication devices may be crowded by other signal sources using the same spectrum. The radio communication devices experience signals received from these signal sources as interference which degrades the quality of communications, and this interference should be taken into account in the communications.

### BRIEF DESCRIPTION

According to an aspect of the present invention, there is provided a method as specified in claim 1.

According to another aspect of the present invention, there is provided an apparatus as specified in claim 14.

According to another aspect of the present invention, there is provided a radio communication device as specified in claim 27.

According to another aspect of the present invention, there is provided an apparatus as specified in claim 28.

According to yet another aspect of the present invention, there is provided a computer program product embodied on a computer readable distribution medium as specified in claim 29.

Embodiments of the invention are defined in the dependent claims.

### LIST OF DRAWINGS

Embodiments of the present invention are described below, by way of example only, with reference to the accompanying drawings, in which

FIG. 1 illustrates a modern communication environment;

FIG. 2 illustrates a process for taking an interference environment into account in radio communications according to an embodiment of the invention;

FIG. 3 is a signaling diagram illustrating communications according to an embodiment of the invention;

FIG. 4 is a flow diagram illustrating a process for predicting future interference according to an embodiment of the invention;

FIGS. 5A and 5B illustrate two embodiments for configuring transmission parameters matching with the predicted interference according to an embodiment of the invention;

FIGS. 6A and 6B illustrate allocation of transmission parameter configurations according to an embodiment of the invention;

FIG. 7 illustrates the structure of a radio communication apparatus according to an embodiment of the invention; and

FIG. 8 illustrates another embodiment of a process for configuring transmission parameters.

### DESCRIPTION OF EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

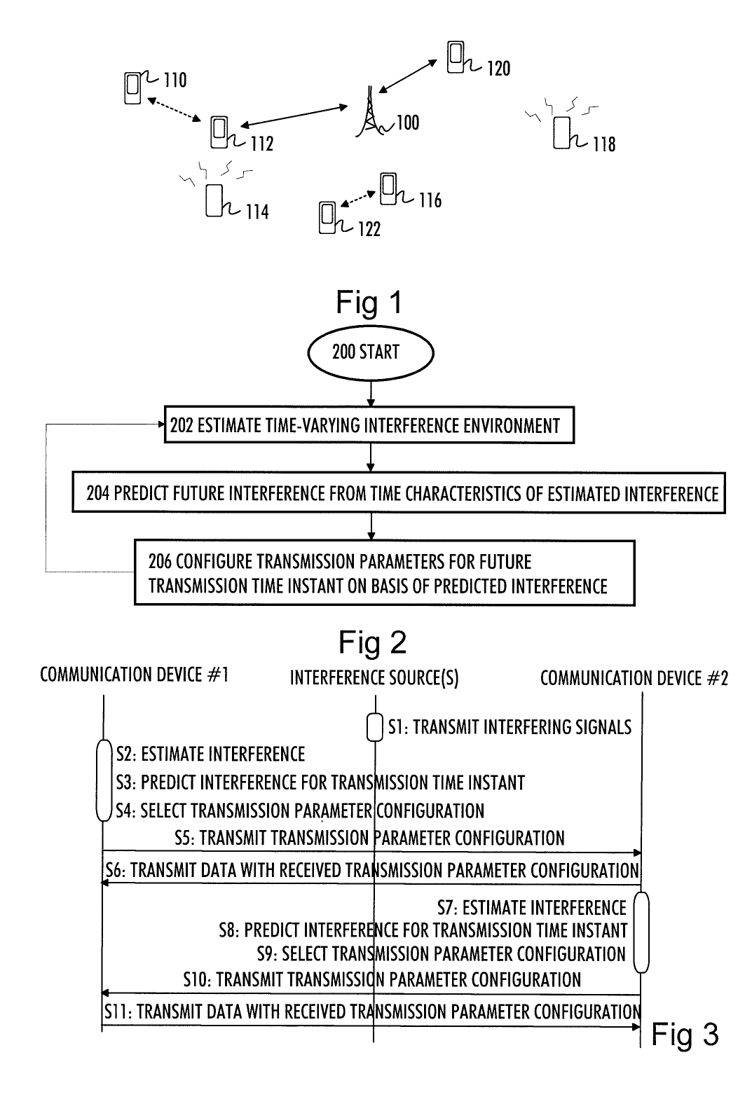

FIG. 1 illustrates a communication environment which is quite typical nowadays. Almost everybody has a cellular telephone and, additionally, other portable communication devices, such as laptops, PDAs, gaming devices, are equipped with radio communication capabilities. Additionally, numerous scanners, sensors, broadcast transmitters, etc. exist that use a radio spectrum. In FIG. 1, communication devices 112 and 120 communicate with a fixed wireless access point 100 which may provide the devices 112 and 120 with voice services or a connection to the Internet, for example. The devices 112 and 120 may communicate with an access point 100 by using a communication protocol according to IEEE 802.11x (wireless local area network, WLAN) or another mobile communication standard, e.g. GSM or UMTS or one of its evolution versions (long-term evolution, LTE, or LTE advanced). Additionally, communication devices 110 and 112 have established an end-to-end communication connection between the devices 110, 112 directly over a short-range communication connection. Devices 116 and 122 have a similar connection established between them. Additionally, the communication environment includes a short-range broadcast transmitter 114 which broadcasts location-based information to cellular phones within a limited area. Moreover, a radar sensor of a door opener 118 scans periodically for presence of traffic triggering a door-opening function. Different types of radio devices impose interference on each other inherently or through their practical non-idealities, such as spectral leakage.

Many of the modern telecommunication systems estimate a current interference environment and determine transmission parameters for future transmission on the basis of a current situation. One example is to estimate a current signal-to-interference-plus-noise ratio (SINR) or a signal-to-interference ratio (SIR), and to map the SINR or SIR to a modulation and coding scheme to be used in a future transmission. In the case of slow variations, such as path loss, shadowing, etc., this method is suitable, because such properties evolve slowly. If the interference is caused by other transmitters transmitting bursty signals periodically, for example, the interference environment may change rapidly, and a conventional scheme may result in suboptimal selection of the modulation and coding scheme. Interference that was present at the time the SINR was calculated may have ceased its bursty transmission when the modulation and coding scheme is actually applied to the transmission, which leads to inefficient data throughput. On the other hand, new bursty interference may have appeared after the estimation of the SINR, which leads to an increased error rate or even packet loss, because the selected modulation and coding scheme is not sufficiently robust.

An embodiment of the invention presents a cognitive radio communication device capable of sensing the current interference environment, predicting its evolvement, and selecting transmission parameters proactively to match with a future environment. An advantage is that the radio communication device estimates a future interference environment and selects the parameters that are optimal for the future environment instead of selecting future transmission parameters that are optimal for the current interference environment.

FIG. 2 is a flow diagram illustrating a method or a process for configuring transmission parameters in a radio communication device. The process may be executed as a computer program in the radio communication device. The process starts in block 200. In block 202, a time-varying interference environment in a radio communication channel is estimated. The estimation may be based on a pilot signal received from another radio communication device with which radio communication is being conducted. The estimation may include estimation of a time profile of the interference, as will be described in greater detail below. In block 204, a future interference environment is predicted from time-varying characteristics of the estimated interference. In block 206, a radio transmitter is configured proactively to adapt to the predicted interference environment by applying transmission parameters to be used in a future transmission time instant for which the interference environment has been predicted.

The process of FIG. 2 is executed in an apparatus applicable to a radio communication device. Such an apparatus may include a processor or a controller configured by a computer program defining operational instructions for the apparatus. In practice, the computer program instructs the apparatus to carry out the process of FIG. 2.

The process of FIG. 2 can be executed in a number of ways during radio communication. FIG. 3 illustrates a signaling diagram where two communication devices both execute the process of FIG. 2 when communicating with each other. In S1, an interference source transmits interference signals to a radio channel through which communication devices #1 and #2 communicate with each other. Let us assume that the interfering signals are located at least partly on the same transmission resources, e.g. frequency, as those used by the communication devices #1 and #2. In S2, a first communication device #1 estimates the interference environment on the transmission resources, e.g. frequency. The estimation may be based on reception of a periodically transmitted pilot signal from a second communication device #2. As a result of processing the pilot signal, the first communication device #1 is capable of determining the interference signals in the air interface during the transmission of the pilot signal. As the pilot signal is known at both communication devices, the first communication device is able to remove its effect from the received signal so that the residual signal includes only the interference signals and noise.

In S3, the first communication device #1 predicts future interference from the interference estimated in S2. In practice, the estimation of the future interference is carried out on the basis of detected regularities in the estimated past interference by extrapolating the regularities into a future transmission time instant at which transmission is carried out. The first communication device #1 may estimate in S2 a past interference strength profile as a function of time for the interference and predict, in S3, a future interference strength profile as the function of time for the interference at the future transmission time instant by extrapolating the past interference strength profile to the future transmission time instant. Further embodiments for predicting the future interference are set forth later.

In S4, a transmission parameter configuration is selected for the transmission time instant on the basis of the interference predicted for the same transmission time instant in S3. The selection of the transmission parameter configuration may include selection of a modulation scheme, a channel coding scheme, a puncturing pattern, a multi-antenna processing scheme (selection between beamforming and spatial multiplexing, for example), etc. Additionally, S4 may include preventing the transmission in the transmission time instant, if the predicted interference indicates that the interference strength will exceed a determined threshold at the transmission time instant. The threshold may be set for example in such a manner that the interference having the strength comparable to the threshold causes erroneous reception in the transmission time instant with a high probability. In such a case, it is reasonable to change the transmission time instant.

In S5, the first communication device #1 transmits the transmission parameter configuration to the second communication device #2 in the form of signaling information. In practice, the number of different transmission parameter combinations may be lower than the maximum number of different configurations that can be derived from those transmission parameters that can be affected so that the word length used to signal the transmission parameters can be reduced. In response to reception of the transmission parameter configuration from the first communication device #1, the second communication device #2 configures its transmitter part to apply the transmission parameter configuration at the transmission time instant. The transmission time instant to which the transmission parameters are to be applied may also be indicated as signaling or it may be obvious to both devices #1 and #2 implicitly. Similarly, the first communication device configures its receiver components to apply the transmission parameter configuration to reception of data from the second communication device in the transmission time instant. In S6, the second communication device #2 transmits the data to the first communication device #1 in the transmission time instant with the transmission parameter configuration indicated in 55, and the first communication device #1 receives and processes the data from the second communication device #2 in the transmission time instant with the transmission parameter configuration selected in S4.

In steps S7 to S11, the same procedure is carried out but now the second communication device carries the interference prediction for another transmission time instant in which the first communication device #1 is configured to carry out transmission of data to the second communication device #2. In practice, step S7 corresponds to step S2, step S8 corresponds to step S3, step S9 corresponds to step S4, step S10 corresponds to step S5, and step Si 1 corresponds to step S6. In other words, the same procedure is carried out in both communication devices in parallel so that the interference prediction may be executed and applied to transmission in both communication directions.

In another embodiment of the procedure of FIG. 3, the selection of the transmission time instants, i.e. scheduling of transmission, is also carried out on the basis of interference prediction. In such a case, the interference may be predicted in S3 and S8 for a plurality of future transmission time instants, and the communication devices may select in S4 and S9 the transmission time instant(s) that exhibit the lowest interference strength. Additionally, the transmission parameter configuration is selected in S4 and S9. In S5 and S10, scheduling is exchanged between the communication devices together with the transmission parameter configuration.

In the procedure described above in connection with FIG. 3, the interference prediction is carried out in a receiver, and the transmission parameters matching the predicted interference are selected and transmitted to the transmitter. One skilled in the art appreciates that a number of other equivalent embodiments exists. The interference prediction may be carried out only in one end of the radio link, e.g. in the first communication device #1. In order to apply the prediction in both communication directions, the second communication device may periodically transmit channel state information indicating, for example, a radio channel impulse response to the first communication device #1. The first communication device may then predict the interference in its downlink direction as described above, and it may also predict the interference in its uplink direction from the received channel state information, select the transmission parameters, and indicate the transmission parameters to the second communication device #2 to enable reception. If the radio channel is reciprocal, i.e. the same in both communication directions, the first communication device does not even require the reception of the channel state information from the second communication device. Moreover, instead of exchanging the transmission parameter configuration between the transmitter and the receiver, the transmitter and receiver may exchange channel state information indicating the interference strength in the given transmission time instant. In such a case, both the transmitter and the receiver may utilize the same mapping table mapping the interference strength to transmission parameters and apply the transmission parameters that are mapped with the exchanged channel state information. Other variations are also possible.

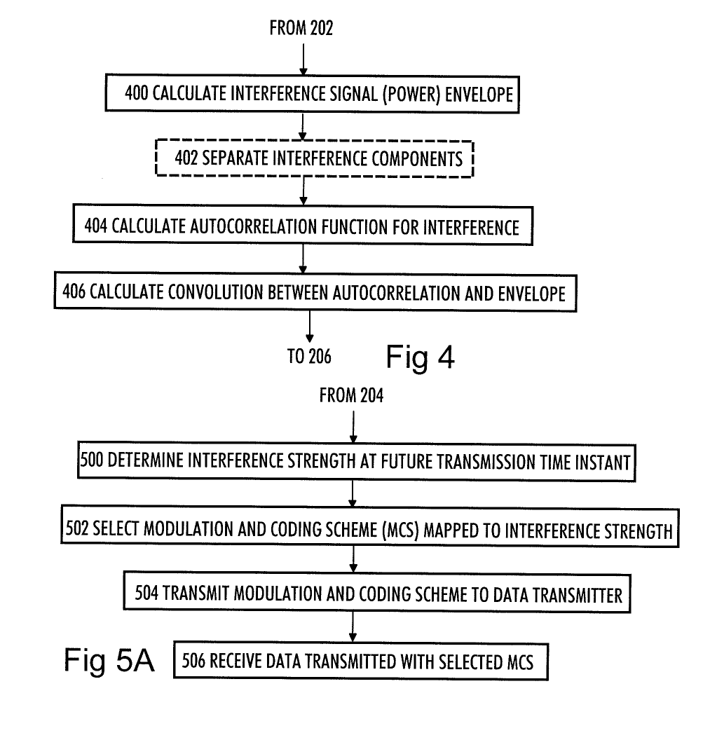

FIG. 4 illustrates an embodiment of the interference prediction, which describes block 204 of FIG. 2 in greater detail. In block 400, an interference signal power envelope is calculated within a time window of a determined length to obtain an interference strength profile as a function of time. A frequency-dependent path loss between the transmitter and the receiver may also be estimated and removed from the profile to obtain an effective interference strength profile for a signal transmitted from the transmitter to the receiver. Instead of power, an amplitude or another metric describing the strength of the interference may be used. In block 402, interference components associated with different interference sources are separated by using a feature detection or a multi-user detection algorithm known in the art. The operation of such algorithms is obvious to a person skilled in the art, e.g. from “Spectrum Sensing in Cognitive Radios based on Multiple Cyclic Frequencies” Lunden J, Koivunen V, Huttunen A, and Poor H. V., 2^{nd} International Conference on Cognitive Radio Oriented Wireless Networks and Communications, 2007, and thus further description is omitted. The execution of block 402 is optional or it can be selectively omitted, because in many scenarios the prediction can be made without the separation of interference components. In block 404, an autocorrelation function is calculated for the interference profile calculated in block 400. The time window for the autocorrelation function may be the same as the time window in block 400. Block 402 may be executed selectively, for example, if the process cannot derive a regularity from the interference profile. For example, block 402 may be executed if the autocorrelation function does not include a peak that exceed a defined peak threshold value. In such a case, the process may determine that the interference profile does not exhibit sufficient correlation and signal component separation is needed to derive the regularity separately for each interference component. When interference component separation is implemented, block 404 (and block 406) is executed for each interference component. In block 406, a convolution is calculated between the autocorrelation function calculated in block 404 and the interference profile calculated in block 400 in order to determine the interference pattern in a future transmission time instant t defined as a time-offset in the convolution. If the convolution is calculated for multiple interference components, the result of the multiple convolutions may be combined at this stage in order to determine the combined interference strength in the transmission time instant t. Then, the (combined) interference strength may be compared in block 206 with transmission parameter configurations stored in a table as being mapped to different interference powers and a transmission power configuration mapped to the predicted interference strength in the table is selected for use in the transmission time instant t.

As a practical example referring to FIG. 1, the access point 100 may share a frequency band with one of the sensors, e.g. the sensor 118. The sensor 118 may be configured to transmit periodical signal pulses in order to detect the presence of a person in the scanning area of the sensor 118. The period may be 100 ms, for example. The access point may constantly monitor the frequency spectrum and measure the signal strength in the spectrum. The strength versus time profile measured by the access point 100 shows the periodical pulses of the sensor. By using the autocorrelation function, the access point detects the presence of a correlation peak with the time offset 100 ms in the autocorrelation function. With the convolution function, or another prediction function or process, the access point 100 can extrapolate the occurrence of the sensor transmission into the future and determine the time periods when the interference caused by the sensor scanning is present. Then, the access point 100 can select a transmission parameter configuration capable of sustaining higher interference levels for transmission in those transmission time instants when the interference is higher in order to maximize the transmission reliability. Similarly, the access point 100 may select a transmission parameter configuration capable of providing higher data rates for transmission in those transmission time instants when the interference is lower or non-existent in order to maximize the throughput. Spectral efficiency is improved in both cases, because the transmission parameters are selected to match the predicted channel state.

In another example, the broadcast transmitter 114, the sensor 118 and the communication devices 116, 122 utilize the same frequency spectrum as the access point 100. The communication devices 116, 122 may communicate with each other by using a voice over Internet protocol (VoIP) application. In this case, the sum of the interference signals from these sources 114 to 118, 122 does not necessarily provide an autocorrelation function that produces a sufficient peak, i.e. the access point cannot deduce a sufficiently regular time profile in the interference strength. This may trigger a feature (or multi-user) detection algorithm which separates signals from different sources. The feature detection algorithm may base the signal separation on detection of presence of cyclic prefixes in the signals, detection of periodically transmitted pilot signals or other reference signals, analysis of pulse shapes and/or analysis of spectrum shapes, for example. Multi-antenna reception and spatial signal processing may also be used in the feature detection so that the different interference source may be separated on the basis of the direction of signal reception. After the feature detection, the autocorrelation function typically detects autocorrelation in the separated signals, which enables the prediction.

The prediction is particularly efficient when the interference has a regular time profile, particularly when the interference is periodic. Then, the autocorrelation function or another second order statistics function shows the cyclic nature of the interference and enables prediction of an interference level at a future time instant, based on estimated interference levels from past time instants. Such interference includes periodic transmissions caused by sensors or radars and communications exhibiting a regular or predictable on/off structure, e.g. VoIP transmission. One feature of the autocorrelation function is that it indicates an amount of information that can be obtained about the future of a signal when the history of the signal is known.

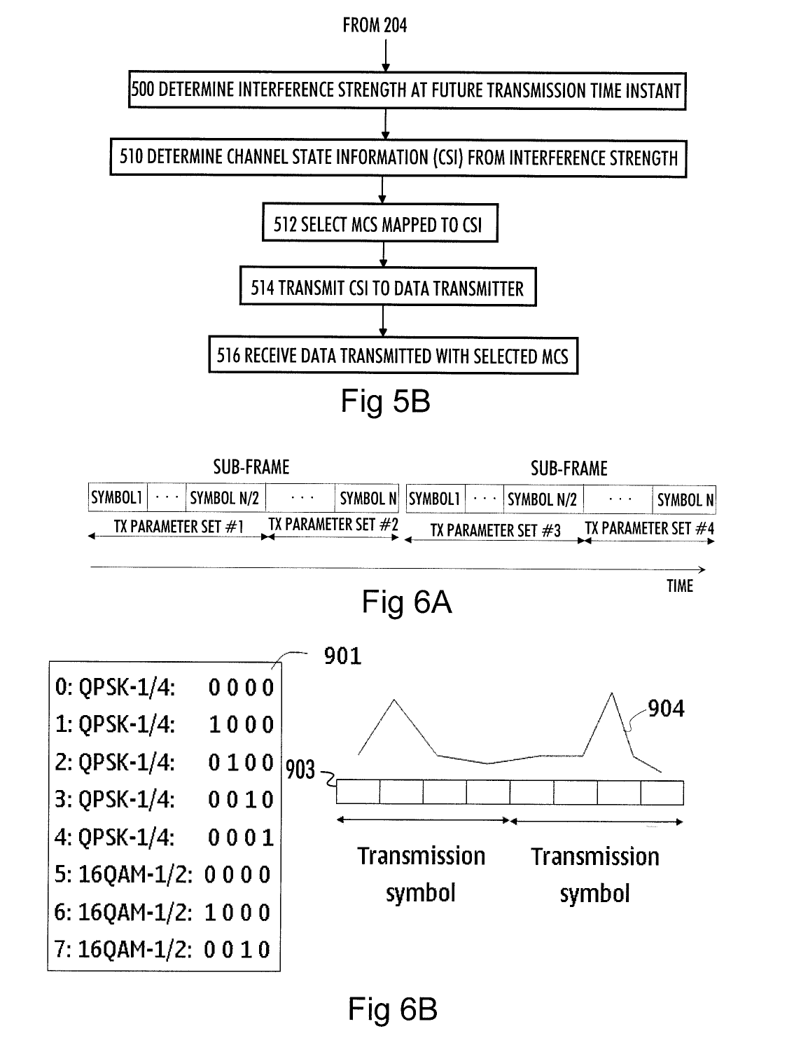

As mentioned above, the indication of the transmission parameter configuration between the communication devices may be carried out in a number of ways. FIGS. 5A and 5B illustrate two embodiments for indicating the transmission parameters, wherein the processes of FIGS. 5A and 5B are carried out in the receiver carrying out the interference prediction. The embodiments describe the operation in step 206 in greater detail. Referring to FIG. 5A, the interference strength is determined in block 500 for a future transmission time instant in which data transmission from the transmitter to the receiver is agreed. In block 502, the receiver selects a modulation and coding scheme which is mapped to the interference strength determined in block 500. Mapping between different interference strengths and modulation and coding schemes may be stored as table values in a memory unit of the receiver. In block 504, the receiver transmits the selected modulation and coding scheme to the transmitter. In block 506, the receiver receives data transmitted by the transmitter in the transmission time instant with the selected modulation and coding scheme. The receiver then demodulates and decodes the received data according to the selected modulation and coding scheme.

In the embodiment of FIG. 5B, the transmission parameter configuration is signaled by using a channel state indicator indicating implicitly both the strength of the interference for the transmission time instant and transmission parameter configuration to be applied. Referring to FIG. 5B, the process executes the same block 500 as the process of FIG. 5A in order to predict the interference strength in the transmission time instant. In block 510, the receiver determines channel state information (CSI) from the interference strength. In practice, the CSI is an indicator of the interference strength, and it can denote a SINR or SIR for the transmission time instant. In block 512, the receiver selects a modulation and coding scheme mapped to the CSI determined in block 510. In block 512, the receiver transmits the CSI to the transmitter. Blocks 512 and 514 may be executed in reversed order or even in parallel. In block 516, the receiver receives the data transmitted from the transmitted in the transmission time instant with the selected modulation and coding scheme. The receiver then demodulates and decodes the received data according to the selected modulation and coding scheme.

A message carrying the transmission parameter configuration or the CSI may include a plurality of transmission parameter configurations or CSIs for multiple transmission time instants, i.e. for a duration longer than a single transmission instant. This reduces the number of signaling messages defining the transmission parameters.

The processes or methods described in FIGS. 2 to 5B may also be carried out in the form of a computer process defined by a computer program. The computer program may be in source code form, object code form, or in some intermediate form, and it may be stored in some sort of carrier, which may be any entity or device capable of carrying the program. Such carriers include a record medium, computer memory, read-only memory, electrical carrier signal, telecommunications signal, and software distribution package, for example. Depending on the processing power needed, the computer program may be executed in a single electronic digital processing unit or it may be distributed amongst a number of processing units.

Instead of, or in addition to, the modulation and coding scheme, the determined transmission parameter configuration may include one or more of the transmission parameters listed above, namely a puncturing pattern and a multi-antenna processing scheme. The puncturing pattern may be indicated in the transmission parameter configuration with a code word that indicates also the other transmission parameters, e.g. the modulation and coding scheme. Alternatively, the puncturing pattern may be transmitted separately as a set of coefficients that describe the puncturing density and parity bit(s) that are to be punctured. The puncturing pattern may define a time-varying puncturing pattern that is applied for a given period of time in the transmission. The puncturing pattern may have the form of a polynomial p(j)=a₀+a₁j+a₂j²+ . . . , wherein j represents a time index and a duration for which each coefficient applies. The polynomial defines an increment in the positions of parity bits that are to be transmitted. For example, if a₀=1.2 and a₁=a₂= . . . =0, an algorithm determining the punctured bits may initialize a variable X=0 and increment X by p(j)=a₀ and round the result towards zero to determine an index of the parity bits to be included in the transmission at position j. In this example:

X=0+1.2=1.2→1 (the first parity bit is included);

X=1.2+1.2=2.4→2 (the second parity bit is included);

X=2.4+1.2=3.6→3 (the third parity bit is included);

X=3.6+1.2=4.8→4 (the fourth parity bit is included);

X=4.8+1.2=6→6 (the sixth parity bit is included and the fifth is skipped and, thus, punctured);

X=6+1.2=7.2→7 (the seventh parity bit is included);

and so on.

In another embodiment, the coefficients of the polynomial p(j) define a puncturing threshold with which a pseudo random number sequence is compared. Each parity bit is mapped to a number in the pseudo random number sequence, and the puncturing of the parity bit is determined on the basis of whether or not it exceeds the threshold. For example, if a given number in the pseudo random number sequence is below the puncturing threshold, the parity bit mapped to that number is punctured. The setting of the threshold effectively defines also the puncturing density.

The transmission parameter configuration may be selected for a given transmission time instant which may be a radio frame, a sub-frame included in the radio frame and being shorter than the radio frame, or a transmission symbol. Depending on the nature of both an interfering and an interfered radio system, the duration of predicted interference bursts may vary greatly, compared to the duration of a transmit symbol of the interfered system. A predicted interference burst may extend over several times the length of a transmit symbol of the interfered system. Alternatively, the interference burst may be very short, compared to one symbol length of the interfered system. One particular example of an interfering system is ultra-wideband (UWB) pulse radio technology, where the transmit power of the UWB system is concentrated in a stream of narrow bursts with a high power density and a duration that will be typically much shorter than a transmission symbol of the interfered system. One example of such an interfered system is UMTS long-term evolution which utilizes single-carrier frequency division multiple access (SC-FDMA) in uplink. The SC-FDMA scheme is a linearly pre-coded OFDM (orthogonal frequency division multiplexing) scheme where each SC-FDMA symbol carries a plurality of information symbols In SC-FDMA, the information symbols are localized in time domain which effectively enables definition of a unique transmission time instant for each information symbol contained in the SC-FDMA symbol.

The interference environment may change rapidly and vary within the SC-FDMA symbol having a rather long duration. As a consequence, the duration of the SC-FDMA symbol (or another equivalent multi-carrier symbol carrying information symbols that localize in the time domain) may be divided into a plurality of sections and transmission parameters may be selected separately for each section. The interference prediction may provide a prediction with sufficient resolution that enables detection of the variance in interference strength within the SC-FDMA symbol. As a consequence, the transmission parameter configurations optimizing the spectral efficiency during the transmission of the SC-FDMA symbol may be selected by selecting a transmission parameter configuration for each section of the SC-FDMA symbol separately. Naturally, a lower time-resolution may be an alternative implementation, wherein signaling requirements are lower, because the transmission parameters are signaled for a longer duration. FIG. 6A illustrates two consecutive sub-frames carrying symbols, e.g. SC-FDMA symbols, where symbols contained in each sub-frame can be distinguished in the time domain. Each sub-frame is divided into two sections. The interference strength is predicted and a transmission parameter configuration is selected independently for each section. As a consequence, a different transmission parameter configuration may be selected for the different sections within the same sub-frame, and different transmission parameter configurations may be selected for consecutive sub-frames. The spectral efficiency is thus improved as the resolution of the transmission parameter selection is raised. The sub-frame symbol may naturally by divided into a higher number of sections, e.g. four sections, and the number of sections may be arranged so high that each SC-FDMA symbol is divided into a plurality of sections. Changing the transmission parameter configuration between the sections may also comprise disabling transmission and reception of a given section, i.e. preventing transmission at a given time instant.

FIG. 6B illustrates an embodiment of a transmission parameter configuration set 901 that includes a time-varying puncturing pattern. FIG. 6B Illustrates two subsequent transmission symbols, each comprising four sub-symbols 903. A graph 904 above the sub-symbols depicts the predicted level of interference during the sub-symbols. The puncturing pattern in the transmission parameter configuration set 901 is exemplary shown as the location of bit value 1 bit per sub-symbol, wherein the location of 1 denotes a lower puncturing density for the sub-symbol in the corresponding location in the transmission symbol. Absence of bit value 1 denotes the same puncturing density for all sub-symbols. Naturally, the modulation and basic code rate would typically also be indicated in binary words, but are shown in a text form for clarity.

Based on the predicted level of interference 904, the receiver selects in this example index 2 for the first transmission symbol and index 3 for the second transmission symbol, ensuring a more robust puncturing pattern during the sub-symbols that are predicted to suffer from stronger interference. In this case, the sub-symbols experiencing from higher predicted interference are assigned with a lower puncturing density. Transmission of only the two indices associated with the two transmission symbols would advantageously result in low signaling overhead when compared with signaling a single index per sub-symbol. In the shown example with eight possible index values (eight transmission parameter configurations), the selection of modulation order, code rate, and time-varying puncturing pattern may be signaled with 3 bits per transmission symbol. One skilled in the art appreciates that not only the puncturing pattern, but also the modulation order or any other transmission parameter may be adapted to a time-varying pattern and signaled with a single index. The skilled person also appreciates that the number of possible transmission parameter configurations may be different than what is disclosed herein.

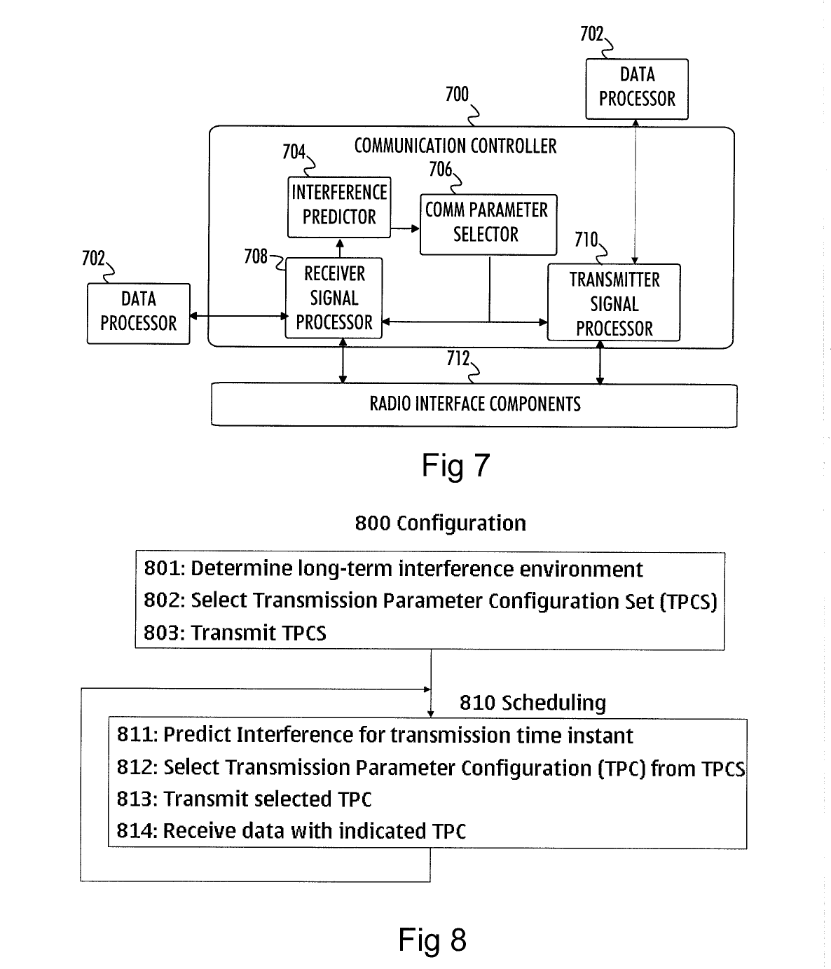

FIG. 7 illustrates a structure of a radio communication device according to an embodiment of the invention. The radio communication device comprises a communication controller 700 configured to control radio communications of the radio communication device. The communication controller 700 may be implemented by one or more processors. The processor(s) may be configured by software or ASIC (application-specific integrated circuit). The communication controller 700 and the radio communication device thus form embodiments of an apparatus according to the present invention.

The radio communication device comprises radio interface components 712 capable of carrying out signal processing according to physical layer protocols of one or more radio communication schemes supported by the terminal device. Such schemes may include cellular telecommunication schemes (GSM, UMTS, WLAN) or short range device-to-device communication schemes, such as Bluetooth. The radio interface components 712 may include analog signal processing elements capable of providing analog signal processing operations according to the range of radio access technologies supported by the radio communication device. Such operations include A/D and D/A conversion for reception and transmission signals, respectively, filtering, frequency conversion, amplification, etc.

Digital signal processing related to reception of data and control signals is carried out in a receiver signal processor 708 configured to carry out demodulation, detection and decoding of data according to a transmission parameter configuration corresponding to that used for processing data in a transmitter (another radio communication device) with which the radio communication device communicates. The transmission parameter configuration may be received from a communication parameter selector 706 selecting the transmission parameter configuration for the radio communication device or, alternatively, the transmission parameter configuration may be received from the transmitter through the radio interface components 712. In the latter case, the receiver signal processor 708 may forward a control message carrying the transmission parameter configuration to the communication parameter selector 706 which processes the control message and configures the receiver signal processor 708 to apply the transmission parameter configuration. Upon decoding data received from the transmitter, the receiver signal processor forwards the decoded data to a data processor 702 which carries out higher level data processing.

The receiver signal processor 708 may also be configured to receive a pilot signal or another reference signal usable for channel estimation from the transmitter. The receiver signal processor 708 may forward such a signal to an interference predictor 704 configured to carry out interference estimation and interference prediction according to embodiments of the invention described above. The interference predictor 704 may calculate a prediction describing the evolution of time-varying interference in future time instants, wherein the length of a time window extending to the future is predetermined. It is not necessarily feasible to predict the interference too far into the future, because the interference scenario may change rapidly. The interference predictor 704 may then output the result of the interference prediction to the communication parameter selector 706.

The communication parameter selector 706 may receive, as another input, transmission timing information defining transmission and reception time instants of the radio communication device. The transmission timing information may be agreed between the radio communication devices communicating with each other (scheduling), or it may be made known to both devices in another way. With respect to the reception, the communication parameter selector 706 may check the interference prediction received from the interference predictor 704 for the interference strength in the reception time instants, select transmission parameter configurations that are associated with the predicted interference strengths, and configure the receiver 708 to apply the transmission parameter configurations to the corresponding reception time instants. Additionally, the communication parameter selector 706 configures a transmitter signal processor 710 to create a control message to be transmitted to the other radio communication device in order to instruct the other radio communication device to apply the transmission parameter configuration to the corresponding time instants so that both the transmitter and the receiver side apply the same transmission parameter configuration at the same time instant.

With respect to the transmission, the communication parameter selector 706 may receive the transmission parameter configuration through the radio interface components 712 and the receiver signal processor 708 from the other communication device. Then, the communication parameter selector 706 may control the transmitter signal processor 710 to apply the transmission parameter configuration to the appropriate transmission time instant. Then, the transmitter signal processor 710 codes, modulates, applies corresponding puncturing pattern, etc. for transmission data received from the data processor 702 in order to transmit the data to the other communication device and forwards the processed data to the radio interface components for transmission. Naturally, the operation of the radio communication device and the communication controller 700 may be implemented in a number of different ways. For example, the communication parameter selector 706 may select the transmission parameter configuration for both transmission and reception, when the channel environment is reciprocal, or the interference prediction may be omitted, if it is carried out only in the other communication device.

In an embodiment, the transmission parameter selector 706 carries out scheduling, i.e. allocation of transmission time instants, on the basis of the interference prediction results received from the interference predictor 704 or from the other communication device through the receiver signal processor 708. The communication parameter selector 706 may select transmission time instants that exhibit the lowest interference strength and communicate the selected transmission time instants to the transmitter and receiver elements 708 and 710 and to the other communication device as scheduling information.

In FIG. 7, the interference predictor 704 is an embodiment of an interference prediction circuitry and means for estimating a time-varying interference environment in a radio communication channel for predicting a future interference environment from time-varying characteristics of the estimated interference. The communication parameter selector 706 forms an embodiment of a communication parameter selection circuitry and means for configuring proactively a radio transmitter to apply transmission parameters to be used in a future transmission time instant for which the interference environment has been predicted.

The communication controller 700 and its components 704 to 710 may be implemented by one or more processors which may be driven by software (or firmware), or they may be hardware processors, e.g. ASIC. Naturally, a combination of software and hardware processors is a possible implementation. The processors may include single-core processors and/or multi-core processors. As mentioned above, the communication controller is applicable to a radio communication device comprising the communication controller and a radio communication circuitry, e.g. the radio interface components 712. Additionally, the radio communication device may include a user interface (not shown) and one or more memory units to store software configuring the operation of the radio communication device as well as other data.

FIG. 8 illustrates yet another embodiment for indicating the transmission parameters between two radio communication devices. The process is executed in a first communication device which may be an access point to a network infrastructure, e.g. a base station, or a mobile communication device. In block 801, the long-term interference strength is determined, for example in the interference predictor 704. In block 802, the transmission parameter configuration set is determined (selected) based on the determination in block 801. For example, in an environment where interference is consistently above a given threshold level, the selection in block 802 may be restricted to a more robust parameter configuration set, whereas in a sporadically interfered environment the selection may restrict the parameter configuration set to one that is less robust but provides a higher throughput. In other words, block 802 restricts the set of available transmission parameter configurations. In another embodiment, the parameter set may be adapted to the detected periodicity of the interference. As an example of this, we refer again to FIG. 6B. If the periodicity of the interference is determined to be such that interference spikes will occur predominantly during the second and third sub-symbols of the transmission symbol, the transmission parameter configuration set 901 may be configured to exclude those transmission parameter configurations that allow for more robust puncturing during the first and fourth sub-symbols, shown as indices 1 and 4 in the transmission parameter configuration set of 901. Other transmission parameter configurations may then be added to replace the excluded indices 1 and 4 and to allow for a more robust puncturing pattern during the second and third sub-symbols. For example, illustrated index 1 may be replaced by configuration “BPSK-1/2 0 1 0 0”, and illustrated index 4 may be replaced by “BPSK-1/2 0 0 1 0”.

In 803, the selected parameter set is transmitted from the first communication device to the other communication device. A transmitted message may be an index to a table value indicating the transmission parameter configuration set. The message may describe the index either explicitly or implicitly. The transmission may also be carried out in a broadcast fashion, so that all communication devices communicating with the first communication device are configured efficiently simultaneously. Naturally, the other communication devices may also carry out blocks 801 to 803, and the first communication device may then apply the received parameter configuration sets in transmission to the particular communication device. Steps 801 through 803 as such configure the other communication device(s) with a restrictive set of transmission parameters. This configuration may be done periodically to adjust to the long-term interference environment.

After the initial configuration, a scheduling phase 810 is started where the first communication device selects transmission parameter configurations for scheduled transmission time instants. The actual scheduling of the transmission time instants may also be made in the scheduling phase 810. The first communication device predicts the interference for transmission during a specific time instant (or interval) according to block 811 and selects in block 812 an entry (index) from the transmission parameter configuration set configured in block 800. The first communication device then provides in block 813 the entry to the other communication device for the specific time instant. In an exemplary embodiment, the first communication device may transmit the time instant together with an index to the selected entry to the other communication device. In block 814, the first communication device receives data from the other communication device, wherein the data has been processed in the other communication device with the transmission parameter configuration indicated in block 813 and wherein the first communication device processes the received data with the corresponding transmission parameter configuration.

It will be appreciated by one skilled in the art, that the above can also be adapted to provide the other communication device(s) with instructions on what transmission parameter configuration will be used in a transmission from the first communication device performing the predictions.

The present invention is applicable to the cellular or mobile telecommunication systems defined above but also to other suitable telecommunication systems. Protocols and specifications of mobile telecommunication systems and their elements develop rapidly. Such development may require extra changes to the described embodiments. Therefore, all words and expressions should be interpreted broadly and they are intended to illustrate, not to restrict, the embodiment. It will be obvious to a person skilled in the art that, as technology advances, the inventive concept can be implemented in various ways. The invention and its embodiments are not limited to the examples described above but may vary within the scope of the claims.

1.-29. (canceled)

30. A method, comprising:
estimating a time-varying interference environment in a radio communication channel;
predicting a future time-varying interference environment from time-varying characteristics of the estimated time-varying interference environment;
encoding a time-variant parameter wherein a single value of the time-variant parameter defines at least one transmission parameter for a plurality of sections of a future transmission time instant for which the future time-varying interference environment has been predicted, wherein the time-variant parameter is reflective of time-variance during the future transmission time instant; and
configuring proactively a radio transmitter to apply said time-variant parameter to be used in the plurality of sections.

31. The method of claim 30, wherein the future transmission time instant is at least one of a frame, a sub-frame and a transmission symbol.

32. The method of claim 30, further comprising:
estimating the time-varying interference environment by separating a signal received from the radio communication channel into one or more interference signals associated with different interference signal sources;
determining a time-dependent regularity in each of the one or more interference signals; and
predicting future presence of interference in the plurality of sections from the interference signal source of each interference signal on the basis of the determined regularity by extrapolating the regularity into the future transmission time instant.

33. The method of claim 32, wherein the prediction further comprises:
predicting future timing of a non-continuous interference signal at the future transmission time instant from a past timing regularity of the interference signal; and
predicting the strength of the interference signal in the plurality of sections from a past regularity in the interference strength profile and from the predicted future timing of the interference signal.

34. The method of claim 30, further comprising:
calculating a power envelope of a received signal representing an interference signal;
estimating autocorrelation of the power envelope; and
calculating a convolution between the autocorrelation and the power envelope with a determined time offset to obtain a prediction of the interference environment in a future transmission time instant corresponding to the time offset.

35. The method of claim 30, wherein the time-variant parameter defines time-variance during the future transmission time instant of one or more of the following transmission characteristics: a modulation scheme, a channel coding scheme, a puncturing pattern, and a multi-antenna processing scheme.

36. The method of claim 30, further comprising:
estimating a time-varying interference power in the radio communication channel;
predicting a signal-to-interference-power ratio in the plurality of sections from regularities in the time-varying interference power; and
encoding the time-variant parameter mapped to the predicted signal-to-interference-power ratio in the future transmission time instant.

37. An apparatus comprising:
at least one processor; and
at least one memory including computer program code;
said at least one memory and said computer program code configured to, with said at least one processor, cause said apparatus to perform at least the following:
estimate a time-varying interference environment in a radio communication channel;
predict a future time-varying interference environment from time-varying characteristics of the estimated time-varying interference environment;
encode a time-variant parameter wherein a single value of the time-variant parameter defines at least one transmission parameter for a plurality of sections of a future transmission time instant for which the future time-varying interference environment has been predicted, wherein the time-variant parameter is reflective of time-variance during the future transmission time instant; and
configure proactively a radio transmitter to apply said time-variant parameter to be used in the plurality of sections.

38. The apparatus of claim 37, wherein the future transmission time instant is one of a frame, sub-frame and a transmission symbol.

39. The apparatus of claim 37, said at least one memory and said computer program code configured to, with said at least one processor, cause said apparatus to further perform at least the following:
estimate the time-varying interference environment by separating a signal received from the radio communication channel into one or more interference signals associated with different interference signal sources;
determine a time-dependent regularity in each interference signal; and
predict future presence of interference in the plurality of sections from the interference signal source of each interference signal on the basis of the determined regularity by extrapolating the regularity into the future transmission time instant.

40. The apparatus of claim 37, said at least one memory and said computer program code configured to, with said at least one processor, cause said apparatus to further perform at least the following:
predict future timing of a non-continuous interference signal at the future transmission time instant from a past timing regularity of the interference signal; and
predict the strength of the interference signal in the plurality of sections from a past regularity in the interference strength profile and from the predicted future timing of the interference signal.

41. The apparatus of claim 37, said at least one memory and said computer program code configured to, with said at least one processor, cause said apparatus to further perform at least the following:
calculate a power envelope of a received signal representing an interference signal;
estimate autocorrelation of the power envelope; and
calculate a convolution between the autocorrelation and the power envelope with a determined time offset to obtain a prediction of the interference environment in a future transmission time instant corresponding to the time offset.

42. The apparatus of claim 37, wherein the time-variant parameter defines time-variance during the future transmission time instant of one or more of the following transmission characteristics: a modulation scheme, a channel coding scheme, a puncturing pattern, and a multi-antenna processing scheme.

43. The apparatus of claim 37, said at least one memory and said computer program code configured to, with said at least one processor, cause said apparatus to further perform at least the following:
configure proactively the radio transmitter by transmitting the time-variant parameter to the radio transmitter;
configure a radio receiver to apply reception parameters corresponding to the time-variant parameter; and process, in the radio receiver, a data signal received from the radio transmitter in accordance with the time-variant parameter signaled to the radio transmitter.

44. A non-transitory computer readable memory comprising a computer program code which, when executed by an apparatus including a processor and a memory, is configured to cause the apparatus to:
estimate a time-varying interference environment in a radio communication channel;
predict a future time-varying interference environment from time-varying characteristics of the estimated time-varying interference environment;
encode a time-variant parameter wherein a single value of the time-variant parameter defines at least one transmission parameter for a plurality of sections of a future transmission time instant for which the future time-varying interference environment has been predicted, wherein the time-variant parameter is reflective of time-variance during the future transmission time instant; and
configure proactively a radio transmitter to apply said time-variant parameter to be used in the plurality of sections.

45. The non-transitory computer readable memory of claim 44, wherein the future transmission time instant is one of a frame, sub-frame and a transmission symbol.

46. The non-transitory computer readable memory of claim 44, wherein the computer program code stored in the computer readable memory is further configured to cause the apparatus to:
estimate the time-varying interference environment by separating a signal received from the radio communication channel into one or more interference signals associated with different interference signal sources;
determine a time-dependent regularity in each interference signal; and
predict future presence of interference in the plurality of sections from the interference signal source of each interference signal on the basis of the determined regularity by extrapolating the regularity into the future transmission time instant.

47. The non-transitory computer readable memory of claim 44, wherein the time-variant parameter defines time-variance during the future transmission time instant of one or more of the following transmission characteristics: a modulation scheme, a channel coding scheme, a puncturing pattern, and a multi-antenna processing scheme.

48. The non-transitory computer readable memory of claim 44, wherein the computer program code stored in the computer readable memory is further configured to cause the apparatus to:
estimate a time-varying interference power in the radio communication channel;
predict a signal-to-interference-power ratio in the plurality of sections from regularities in the time-varying interference power; and
encode the time-variant parameter_mapped to the predicted signal-to-interference-power ratio in the future transmission time instant.

49. The non-transitory computer readable memory of claim 44, wherein the computer program code stored in the computer readable memory is further configured to cause the apparatus to:
configure proactively the radio transmitter by transmitting the time-variant parameter to the radio transmitter;
configure a radio receiver to apply reception parameters corresponding to the time-variant parameter; and
process, in the radio receiver, a data signal received from the radio transmitter in accordance with the single time-variant parameter signaled to the radio transmitter.
